(19) United States
(12) Patent Application Publication
(10) Pub. No.: US 2016/0171652 A1
(43) Pub. Date: Jun. 16, 2016

(54) IMAGE SCALER HAVING ADAPTIVE FILTER

(71) Applicant: Samsung Electronics Co., Ltd., Suwon-si (KR)

(72) Inventor: SEUN RYU, Seongnam-si (KR)

(21) Appl. No.: 14/962,271

(22) Filed: Dec. 8, 2015

(30) Foreign Application Priority Data
Dec. 10, 2014 (KR) 10-2014-0177728

(51) Int. Cl. G06T 3/40; H04N 7/01

(52) U.S. Cl. CPC G06T 3/4007; H04N 7/0145

(57) ABSTRACT

An image scaler includes a tap decision unit configured to determine the a number of taps based on a scaling ratio; and a pixel analyzer configured to analyze a frequency characteristic of a corresponding pixel based on the number of taps, the corresponding pixel being one of a plurality of pixels included in a input image.

### CROSS-REFERENCE TO RELATED APPLICATION

This application claims priority under 35 U.S.C. §119 to Korean Patent Application No. 10-2014-0177728 filed on Dec. 10, 2014, the disclosure of which is incorporated herein by reference in its entirety.

### BACKGROUND

1. Field

At least some example embodiments of the inventive concepts relate to an image scaler and a method of scaling an image, and more particularly, to an image scaler with an image having a high quality, and a method of scaling an image.

2. Description of Related Art

Since some digital display devices, such as a liquid crystal display (LCD), a digital-mirror device (DMD), and a plasma display panel (PDP), have a fixed display resolution based on a product, an input image having a variety of resolutions should be converted to match with the resolution of a corresponding display device. In this case, when differences exist between the size of the input image and that of the output image, a scaler may be used to convert the size of the input image, i.e., the resolution of the input image.

In general, the scaler performs an analysis by applying a fixed number of taps in the input image, and selects a scaling filter depending on a scaling ratio.

### SUMMARY

As is discussed above, in general, the scaler performs an analysis by applying a fixed number of taps in the input image, and selects a scaling filter depending on a scaling ratio.

However, such the scaler may not be capable of applying an optimal scaling filter corresponding to an input image signal, and thus fine quality may not be represented with respect to an image.

At least some example embodiments of the inventive concepts provide an image scaler including an adaptive filter and a method of scaling an image.

The technical objectives of at least some example embodiments of the inventive concepts are not limited to the above disclosure; other objectives may become apparent to those of ordinary skill in the art based on the following descriptions.

According to at least one example embodiment of the inventive concepts, an image scaler includes a tap decision unit configured to determine a number of taps based on a scaling ratio, and a pixel analyzer configured to analyze a frequency characteristic of a corresponding pixel based on the number of taps, the corresponding pixel being one of a plurality of pixels included in a input image.

The tap decision unit may be configured to determine the scaling ratio by generating a comparison value based on an image resolution of the input image and an image resolution of the output image.

The tap decision unit may be configured to set the number of taps to n when the scaling ratio is in a range of 1/n to n.

The pixel analyzer may be configured to determine the number of pixels adjacent to the corresponding pixel in response to the number of taps.

The pixel analyzer may be configured to determine color differences between adjacent pixels in a range of the number of taps and analyze frequency characteristics of the corresponding pixel.

According to at least one example embodiment of the inventive concepts, an image scaler may include a processor; and storage storing instructions that, if executed by the processor, cause the processor to, receive an input image; set a number of taps based on resolution of an input image; determine a frequency characteristic of a corresponding pixel, from among pixels included in the input image, based on the number of taps; select a filter coefficient based on the frequency characteristic; and interpolate the input image using the filter coefficient.

The instructions, if executed by the processor, may cause the processor to define a scaling ratio using a ratio of a resolution of an output image to a resolution of the input image.

The instructions, if executed by the processor, may cause the processor to set the number of taps to n when the scaling ratio is in a range of 1/n to n.

The instructions, if executed by the processor, may cause the processor to determine the number of adjacent pixels in based on the number of taps when frequency characteristics of pixels of the input image are analyzed.

The instructions, if executed by the processor, may cause the processor to determine the frequency characteristic of the corresponding pixel by determining color differences between pixels adjacent to the corresponding pixel and determining the frequency characteristic based on the color differences.

The instructions, if executed by the processor, may cause the processor to determine an average value from among absolute values of the color differences, and determine the frequency characteristic by determining whether the average value is greater or smaller than one or more threshold values.

The instructions, if executed by the processor, may cause the processor to select an analysis direction of pixels adjacent to the corresponding pixel in any one of a vertical direction and a horizontal direction.

The image scaler may further include a look-up table which stores a plurality of filter coefficients.

The instructions, if executed by the processor, may cause the processor to choose the selected filter coefficient by choosing a filter coefficient, from among the plurality of filter coefficients stored in the look-up table, that corresponds to the determined frequency characteristic.

The instructions, if executed by the processor, may cause the processor to perform image interpolation on the corresponding pixel using a value determined based on the filter coefficient and a pixel data value of the corresponding pixel.

The instructions, if executed by the processor, may cause the processor to perform image interpolation on the corresponding pixel using a value determined by multiplying the filter coefficient by the pixel data value of the corresponding pixel.

According to at least one example embodiment of the inventive concepts, an image scaler for scaling an input image into an output image may include a processor; and storage storing instructions that, if executed by the processor, cause the processor to, receive the input image, the input image including a plurality of pixels, the plurality of pixels including a first pixel; determine a frequency characteristic of the first pixel based on a set of pixels from among the plurality of pixels; interpolate the first pixel based on the frequency characteristic; and generate the output image based on the interpolated first pixel, the determining including selectively setting a total number of pixels included in the set of pixels based on a scaling ratio.

The instructions, if executed by the processor, may cause the processor to receive the scaling ratio, the scaling ratio indicating a ratio of a resolution of the output image to a resolution of the input image.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 shows output images when various filters are applied to an input image;

FIG. 2 is a peak signal-to-noise ratio (PSNR) graph based on the number of taps;

FIG. 3 is a block diagram of a general image scaler;

FIG. 4 is a block diagram of an image scaler according to at least one example embodiment of the inventive concepts;

FIG. 5 is a block diagram illustrating tap decision of a tap decision unit based on FIG. 4;

FIG. 6A is a view illustrating a pixel analysis in a vertical direction by a pixel analyzer based on FIG. 4;

FIG. 6B is a view illustrating a pixel analysis in a horizontal direction by the pixel analyzer based on FIG. 4;

FIG. 7A is a view illustrating image interpolation of an image interpolator based on FIG. 4 according to at least one example embodiment of the inventive concepts;

FIG. 7B is a view illustrating image interpolation of the image interpolator based on FIG. 4 according to at least another example embodiment of the inventive concepts;

FIG. 8 is a flow chart showing operations of the image scaler based on FIG. 4;

FIG. 9 is a block diagram of a mobile device including the image scaler shown in FIG. 4 according to at least one example embodiment of the inventive concepts;

FIG. 10 is a block diagram of a mobile device including the image scaler shown in FIG. 4 according to at least another example embodiment of the inventive concepts; and

FIG. 11 is a block diagram of a digital system 300 configured to process a digital image and/or a digital video.

### DETAILED DESCRIPTION OF THE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

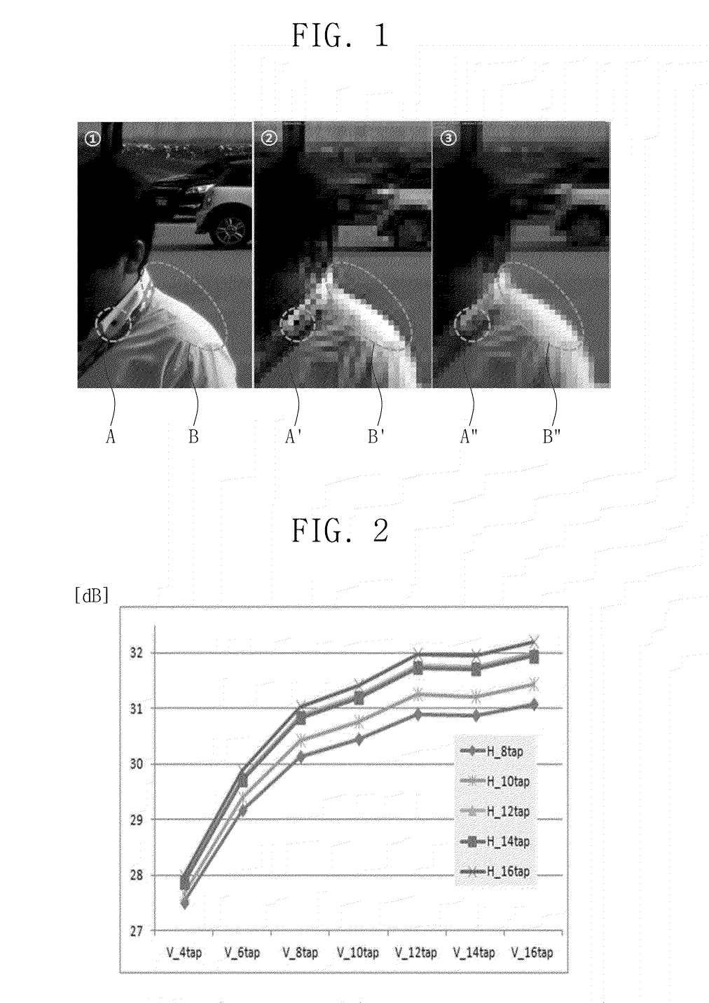

FIG. 1 shows output images when various filters are applied to an input image.

FIG. 1 illustrates images 1, 2 and 3. Referring to FIG. 1, image 1 is an original image, and images 2 and 3 are output images where downscaling is performed using different filters.

In views of areas defined by dashed lines in the original image, an area A defined by a dashed line is an example with a button located in a center of the image, and an area B defined by a dashed line is an example with a boundary of different images. That is, the area A refers to an image having a low frequency component, and the area B refers to an image having a high frequency component. The low frequency component includes a main image or background image. A given pixel having a low frequency component may indicate that image data values of pixels adjacent to or located closely to the given pixel differ a relatively small amount from the image data value of the given pixel. Further, the high frequency component includes a boundary line of images. A given pixel having a high frequency component may indicate that image data values of pixels adjacent or located to the given pixel differ a relatively large amount from the image data value of the given pixel. The frequency component is also referred to herein, at times, a frequency characteristic (frequency component).

When downscaling is performed by applying a high frequency filter, for example, an image 2, image distortion is not generated in a part A′ compared with the part A of 1, but a ringing phenomenon is generated (e.g., ringing artifacts are generated) in a part B′ compared with the part B of 1.

When downscaling is performed by applying a low frequency filter, for example, an image 3, image distortion is not generated in a part B″ compared with the part B of 1, but an excessive blurring phenomenon is generated in a part A″ compared with the part A of 1.

As described above, an image having a low frequency component and an image having a high frequency component may be mixed and coexist in an original image. When one type of a filter is used without consideration of frequency characteristics of pixels, an image corresponding to each frequency component may not be properly displayed. Alternatively, according to at least one example embodiment of the inventive concepts, when filters are selectively used in consideration of frequency characteristics of image pixels, an image having a high quality may be output.

FIG. 2 is a peak signal-to-noise ratio (PSNR) graph based on the number of taps.

Referring to FIG. 2, an X-axis refers to the number of taps required for scaling, and a Y-axis refers to the size [dB] of an output signal (e.g., a ratio between a resolution of the output image and a resolution of the input image). A tap refers to the number of adjacent pixels to be referred to when frequency characteristics of image pixels are analyzed. Here, both a tap in a horizontal direction H_tap and a tap in a vertical direction V_tap are included in experimental conditions.

As is shown in FIG. 2, although the number of taps is increased, the size of the output signal is not increased in proportion to an increase in the number of taps. As a result of experimental conditions of FIG. 2, the size of the output signal is increased in proportion to an increase in the number of taps until a certain level and a saturation state is maintained at the certain level. That is, when frequency characteristics of pixels are analyzed, this denotes that an image having a high quality is not output even though the number of taps is unconditionally increased and the size of a signal is not changed at a certain level. Thus, when image scaling is performed, it is more effective to use a proper number of taps required for the image.

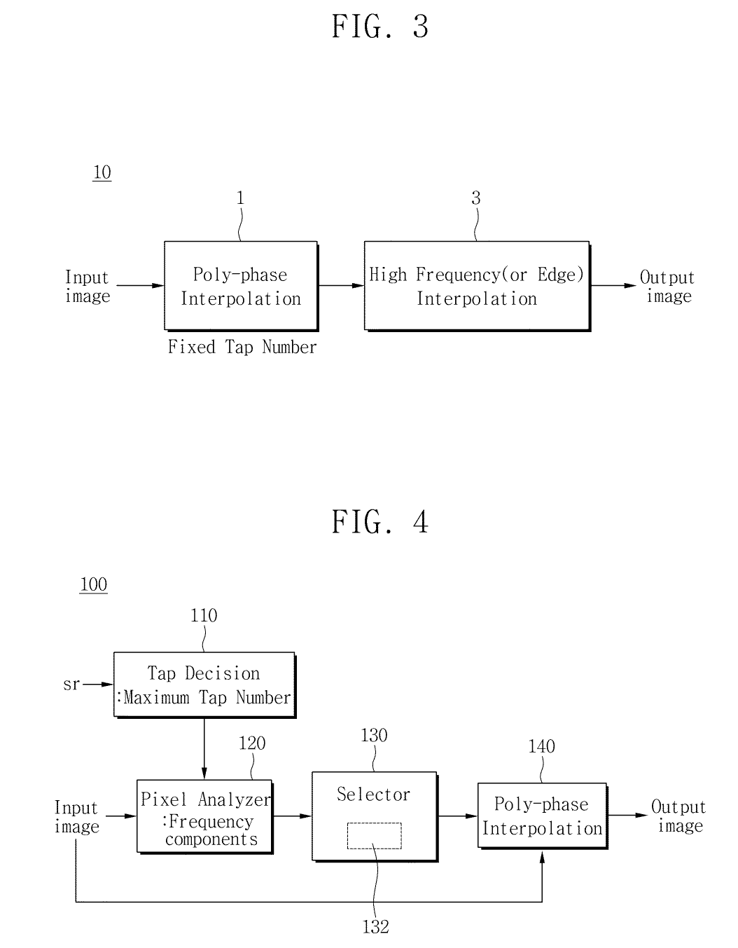

However, a conventional image scaling is performed using the fixed number of taps shown in FIG. 3.

FIG. 3 is a block diagram of a general image scaler.

Referring to FIG. 3, an image scaler 10 includes a poly-phase interpolator 1 and a high frequency interpolator 3.

The poly-phase interpolator 1 receives an input image and scales the input image based on a scaling ratio. Here, a fixed number of taps is applied to the poly-phase interpolator 1. Further, low frequency filtering is basically performed in this example.

Subsequently, an output image may be provided by additionally performing scaling on an image having a high frequency component using the high frequency interpolator 3.

As described above, since the related image scaling scales an image using a fixed number of taps which is set initially (i.e., before the image is input), there is a limit to effective image scaling. That is, since the image scaling is performed using a preset number of taps, an excessive number of taps may be applied. This may be disadvantageous in terms of power efficiency.

Further, since low frequency filtering is first performed and additional high frequency filtering is performed for a necessary area, an excessive amount of computation is performed on corresponding pixels, and thus great power consumption is needed.

FIG. 4 is a block diagram of an image scaler 100 according to at least one example embodiment of the inventive concepts;

Referring to FIG. 4, the image scaler 100 includes a tap decision unit 110, a pixel analyzer 120, a filter selector 130, and an image interpolator 140. According to at least one example embodiment of the inventive concepts, any or all the image scaler 100, tap decision unit 110, pixel analyzer 120, filter selector 130, and image interpolator 140 may be implemented by circuitry structurally configured to perform the operations described herein as being performed by the image scaler 100 (or any element thereof), tap decision unit 110, pixel analyzer 120, filter selector 130, or image interpolator 140. Further, according to at least one example embodiment of the inventive concepts, any or all of the image scaler 100, tap decision unit 110, pixel analyzer 120, filter selector 130, and image interpolator 140 may be implemented by one or more processors executing one or more programs including instructions corresponding to the operations described herein as being performed by the image scaler 100 (or any element thereof), tap decision unit 110, pixel analyzer 120, filter selector 130, or image interpolator 140. The one or more programs may be stored, for example, in storage (e.g., memory) included in, or communicatively connected to, the image scaler 100.

The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multi-core processor; a multiprocessor, an application-specific integrated circuit (ASIC), and a field programmable gate array (FPGA).

The tap decision unit 110 according to at least one example embodiment of the inventive concepts determines the number of taps based on an input scaling ratio sr. That is, the tap decision unit 110 may change the number of taps based on the scaling ratio sr instead of using a fixed number of taps, which is different from the conventional art. The scaling ratio sr may be provided by a system or a user. The scaling ratio sr is a ratio of an output image to an input image. According to at least one example embodiment of the inventive concepts, the tap decision unit 110 may include a maximum number of taps, but may select a variety of different numbers of taps, up to the maximum number of taps, based on the input image.

Equation 1 will be referenced below.

scaling ratio (sr)=output image resolution/input image resolution [Equation 1]

The pixel analyzer 120 may analyze frequency components of pixels included in an input image. Here, the pixel analyzer 120 determines the number of reference pixels related to corresponding pixels based on the number of taps determined from the tap decision unit 110. Thus, the pixel analyzer 120 analyzes whether the frequency component of a corresponding pixel is a high frequency or a low frequency based on the number of taps, and outputs the analysis result. Although described in detail below, the pixel analyzer 120 calculates color differences between n (here, n is the number of taps) pixels around a selected pixel, and may classify and analyze as high and low frequency components (in more detail, high, low, and intermediate frequency components) according to the color differences.

The filter selector 130 may select a filter corresponding to an analysis result of the pixel analyzer 120. The filter selector 130 includes a look-up table 132, and may load a filter coefficient corresponding to frequency characteristics and the number of taps from the look-up table 132. Although the look-up table 132 is discussed with respect to an example in which the look-up table is included in the filter selector 130, the look-up table 132 may exist as a database separated from the filter selector 130. According to at least some example embodiments of the inventive concepts, the filter selector 130 provides a filter coefficient in consideration of the number of taps rather than a location of the look-up table 132.

The image interpolator 140 may perform image interpolation in consideration of a selected filter coefficient and the number of taps with respect to an input image. The image interpolator 140 may output an image value interpolated using a value calculated by multiplying the pixels according to the number of taps by each filter coefficient. The image interpolator 140 may perform the image interpolation in a horizontal or vertical direction.

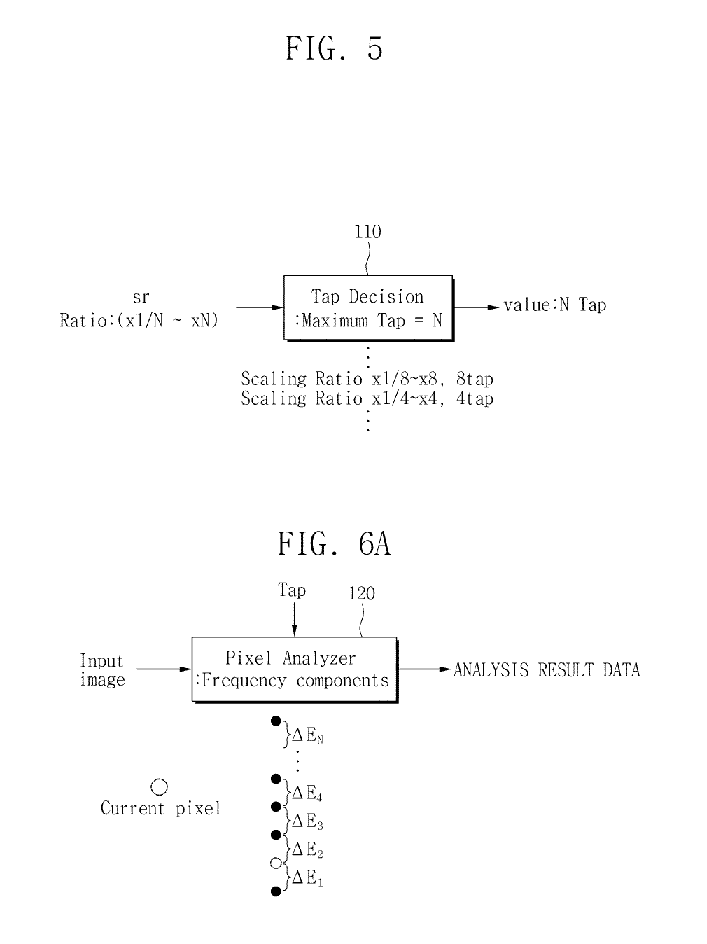

FIG. 5 is a block diagram illustrating a tap decision of a tap decision unit 110 based on FIG. 4.

Referring to FIG. 5, according to at least one example embodiment of the inventive concepts, the tap decision unit 110 may set the number of taps to n when an input scaling ratio sr is in a range of 1/n to n. According to at least one example embodiment of the inventive concepts, the tap decision unit 110 may set the number of taps to n when an input scaling ratio sr is equal to 1/n or n.

For example, when the resolution magnification of an input image is 1 and the resolution magnification of a display device is 1/4 compared to the resolution magnification of the input image, a scaling ratio sr may be 1/4 because 1/4 downscaling with respect to the input image should be performed. Thus, the tap decision unit 110 sets the number of taps to 4 because n is 4.

Otherwise, when the resolution magnification of the input image is 1 and the resolution magnification of the display device for an output image is 8, the scaling ratio sr may be 8 because 8 times upscaling with respect to the input image should be performed. Thus, the tap decision unit 110 sets the number of taps to 8 because n is 8.

In some conventional art, the number of taps is set to a fixed number regardless of a scaling ratio sr. According to at least one example embodiment of the inventive concepts, the number of taps may be selected based on the scaling ratio sr. That is, when the scaling ratio sr is changed for each input image, the number of taps may be varied according to the scaling ratio sr. Accordingly, a proper number of taps may be applied to image scaling according to at least some example embodiments of the inventive concepts.

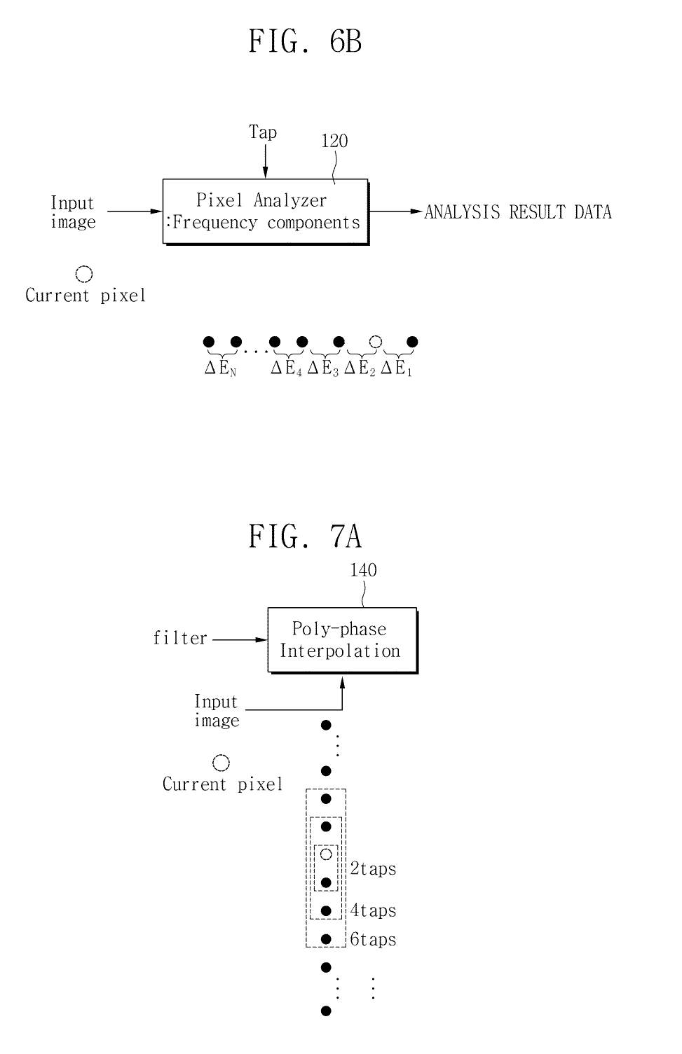

FIG. 6A is a view illustrating a pixel analysis in a vertical direction by the pixel analyzer 120 based on FIG. 4.

Referring to FIG. 6A, a dashed circle refers to a current selected pixel, and a case in which the number of taps may be, for example, 8 is provided as an example.

The pixel analyzer 120 may analyze a frequency component of the current pixel by sampling eight reference pixels including the current selected pixel in a vertical direction. Eight vertical pixels, where the current pixel is located at the center of the eight pixels (e.g., as one of the 2 central pixels), are included in a sampling range.

Equation 2 calculates each distance difference between adjacent pixels corresponding to the number of taps, and more particularly, is shown as a pseudo code for a process of accumulating the absolute value of a color difference. In equation 2, E is a number and is the accumulation of the absolute value of color differences, k is an index value and a positive integer, and ΔEₖ is a number that represents a degree of change in color value corresponding to index k (i.e. a change in color data between adjacent pixels as illustrated in FIGS. 6A and 6B).

$$For \\ ( k = 1 \text{:} N ) \\ E = E + abs ( Δ {E}_{k} ) ; \\ End \qquad [ Equation 2 ]$$

(k means the number of taps, E means accumulation of the absolute value of color differences, and N means a natural number)

Then, frequency characteristics may be analyzed (e.g., by the pixel analyzer 12) by determining whether an average value of the accumulated result is greater or smaller than one or more predetermined or, alternatively, desired values (e.g., threshold values t1, t2, t3, etc.). According to at least some example embodiments, any or all of the one or more predetermined or, alternatively, desired value may be set based on an empirical analysis. The frequency characteristics may be largely classified as two areas such as high and low frequency areas, but in order for a more detailed analysis, an intermediate frequency characteristic between high and low frequency characteristics based on various reference values (e.g., threshold values t1, t2, t3, etc.) may be analyzed. In other words, it may be accumulated the absolute value of color differences as to the number of taps (1 to N) using equation 2. And then, it may be calculated averages A in equation 3 by using k and E of equation 2. Equation 3 will be discussed below.

$$A = E / K ; \\ If ( A < {t}_{1} ) \\ M = 2 ; \\ Else if ( A < {t}_{2} ) \\ M = 4 ; \\ Elseif ( A < {t}_{3} ) \\ M = 6 ; \\ Elseif ( A < {t}_{4} ) \\ M = 8 ; \\ ⋮ \\ End \qquad [ Equation 3 ]$$

(K means the number of taps, A means the average, M means a maximum tap number, and E means accumulation of the absolute value of color differences)

In Equation 3, by determining whether an average value of distance differences between adjacent pixels is greater or smaller than one or more predetermined or, alternatively, desired values, a corresponding frequency characteristic analysis is performed. The value M represents the result of the frequency characteristic analysis. The value M may be decided in consideration of threshold value t. E is defined above with respect to equation 2. According to at least some example embodiments, any or all of the one or more predetermined or, alternatively, desired values may be set based on an empirical analysis. That is, result data of the frequency characteristic analysis is provided as a quantized value, i.e., the value M.

Then, the filter selector 130 (see FIG. 4) may select a scaling filter corresponding to the analysis result data. That is, the filter selector 130 (see FIG. 4) may load a filter coefficient corresponding to the analysis result data from the look-up table 132 (see FIG. 4), thereby implementing a scaling filter.

Furthermore, according to at least some example embodiments of the inventive concepts, the filter coefficient is selected using a result of the frequency characteristic analysis of selected pixels under a condition in which the number of taps is determined.

FIG. 6B is a view illustrating a pixel analysis in a horizontal direction by the pixel analyzer 120 based on FIG. 4.

Referring to FIG. 6B, a dashed circle refers to a current selected pixel, and a case in which the number of taps may be, for example, 8 is provided as an example.

The pixel analyzer 120 may analyze a frequency component of the current pixel by sampling eight reference pixels including the current selected pixel in a horizontal direction. According to at least some example embodiment of the inventive concepts, the current pixel may be located at the center of the eight horizontal reference pixels (e.g., as one of the 2 central pixels).

That is, the pixel analyzer 120 may analyze a frequency component of a pixel using a similar principle for both horizontal and vertical directions.

According to at least one example embodiment of the inventive concepts, analysis of the frequency characteristics with respect to the vertical direction is not performed in parallel with analysis of the frequency characteristics with respect to the horizontal direction. Frequency characteristics may be analyzed when the analysis is performed in any one direction of horizontal and vertical directions.

Therefore, since a necessary filter is selected to perform scaling when a frequency component of a corresponding pixel is analyzed, the application of an additional filter to the corresponding pixel may be omitted.

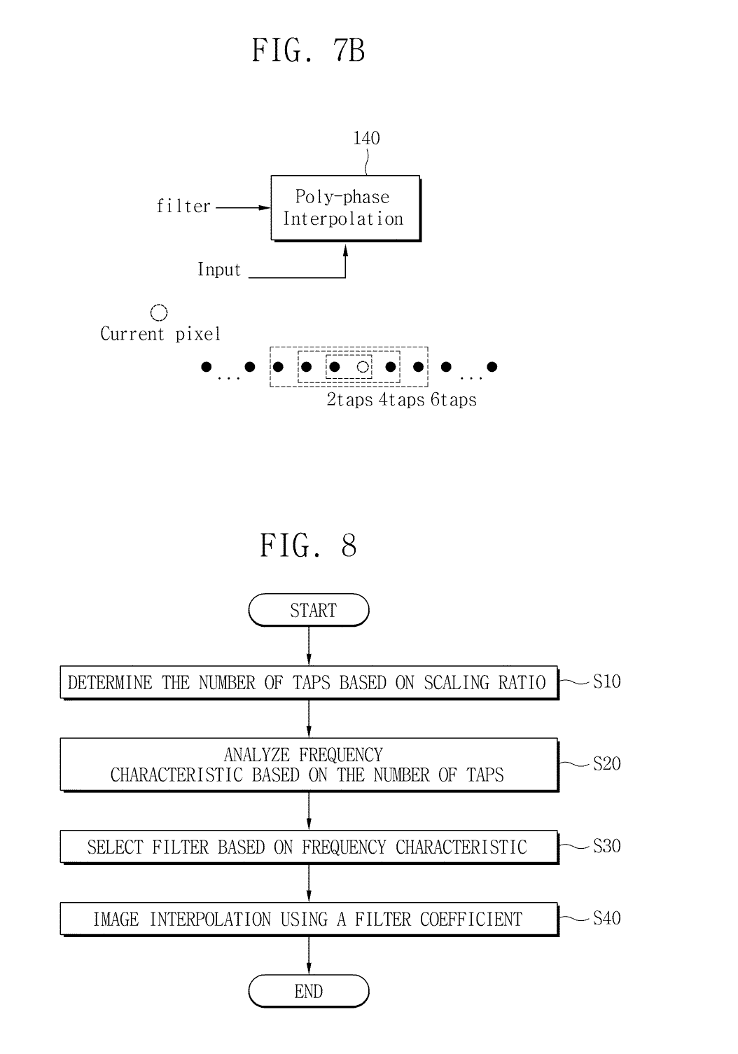

FIG. 7A is a view illustrating image interpolation of the image interpolator 140 based on FIG. 4 according to at least one example embodiment of the inventive concepts.

FIG. 7A, shows that the image interpolation is performed in a vertical direction.

In FIG. 7A, the dashed circle refers to a current selected pixel. s is illustrated in FIG. 7A, the range of image interpolation may be changed based on the number of taps. The image interpolator 140 may perform image interpolation using a value calculated by multiplying pixel data of each pixel by a filter coefficient provided from the filter selector 130 (see FIG. 4) in a previous stage.

For example, when a scaling filter coefficient is M bits, and pixel data is K bits, an image interpolation value is calculated by Equation 4.

image interpolation value=M×K [Equation 4]

(M means a scaling filter coefficient and K means pixel data)

FIG. 7B is a view illustrating image interpolation of the image interpolator 140 based on FIG. 4 according to at least another example embodiment of the inventive concepts.

Referring to FIG. 7B, it shows that the image interpolation is performed in a horizontal direction.

In FIG. 7B, a dashed line of a circle is the currently selected pixel. As is shown in FIG. 7B, the range of image interpolation may be changed based on the number of taps. The image interpolator 140 may perform image interpolation using a value calculated by multiplying pixel data of each pixel by a filter coefficient provided from the filter selector 130 (see FIG. 4) in a previous stage.

FIG. 8 is a flow chart showing operations of the image scaler based on FIG. 4.

Referring to FIGS. 4 and 8, the tap decision unit 110 of the image scaler 100 according to at least one example embodiment of the inventive concepts determines the number of taps based on a scaling ratio sr (S10).

The scaling ratio sr refers to a ratio of an output image to an input image, and the number of taps is determined based on the scaling ratio sr.

The pixel analyzer 120 analyzes frequency characteristics of pixels in consideration of the determined number of taps (S20).

The number of pixels adjacent to a selected pixel is determined based on the number of taps, and a high frequency image or a low frequency image is determined using an average value of color differences or distance differences between the pixels.

The filter selector 130 may select a filter coefficient based on the frequency characteristics.

The filter coefficient may load and select some of values stored in the look-up table 132 of the filter selector 130. The filter coefficient may include coefficient values which are classified as a low frequency type, a high frequency type, an intermediate frequency type between low and high frequency types, etc.

The image interpolator 140 performs image interpolation on selected pixels in the range of the number of taps using a filter coefficient (S40).

Specifically, the image interpolation may be performed using a value calculated by multiplying a selected filter coefficient by a pixel data value. As a result, an output image scaled to be suitable for a scaling ratio sr may be provided.

As described above, according to at least one example embodiment of the inventive concepts, a proper number of taps may be determined using a scaling ratio required for an input image. When scaling computation is performed using the number of taps, an excessive amount of computation may be prevented and a proper amount of computation may be calculated.

Further, since additional pixel scaling is unnecessary for a low or high frequency and additional computation is not needed, power consumption is reduced and the burden of computation time and computation data may also be reduced.

Furthermore, since a filter coefficient is suitable to be used for a frequency characteristic of every pixel, an image characteristic may be properly represented for each pixel. That is, since a low frequency characteristic represents a smooth image and a high frequency characteristic represents a sharp image, the quality of the image may be improved.

FIG. 9 is a block diagram of a mobile device 210 including the image scaler shown in FIG. 4 according to at least one example embodiment of the inventive concepts.

Referring to FIG. 9, the mobile device 210 may be implemented as a smart-phone, a tablet personal computer (tablet PC), an ultra-mobile PC (UMPC), a personal digital assistant (PDA), a portable multimedia player (PMP), an MP3 player, or an MP4 player.

The mobile device 210 may include a memory device 211, an application processor 212 including a memory controller which controls the memory device 211, a modem 213, an antenna 214, a display device 215, and an image sensor 216.

The modem 213 may exchange wireless signals through the antenna 214. For example, the modem 213 may convert a wireless signal received through the antenna 214 into a signal to be processed in application processor 212. In the embodiment, the modem 213 may serve as a long term evolution (LTE) transceiver, a high speed downlink packet access (HSDPA)/wideband code division multiple access (WCDMA) transceiver, or a global system for mobile communications (GSM) transceiver.

Accordingly, the application processor 212 may process a signal output from the modem 213 and transmit the processed signal to the display device 215. The modem 213 may convert a signal output from the application processor 212 into a wireless signal and the converted wireless signal may be output to an external device through the antenna 214.

The image sensor 216 receives an image through a lens. Accordingly, the application processor 212 receives an image from the image sensor 216, and the received image signal is processed in image. The application processor 212 includes image scaler 100 (i.e., the image scaler 100 shown in FIG. 4). The image scaler 100 may properly perform scaling in consideration of a scaling ratio of an output image to an input image, and an image having a high quality may be provided in consideration of a frequency characteristic of each pixel.

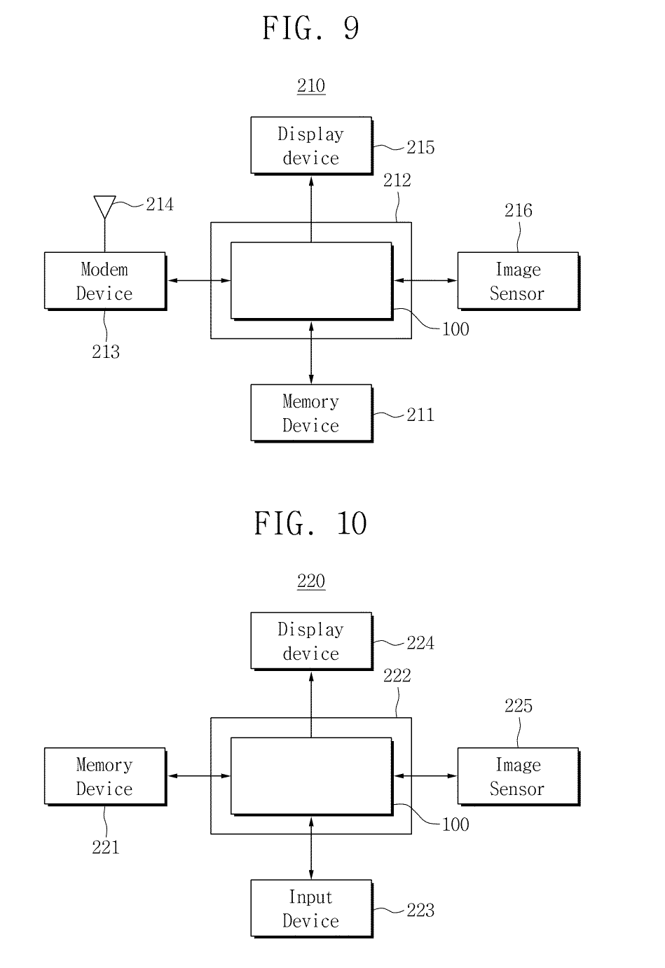

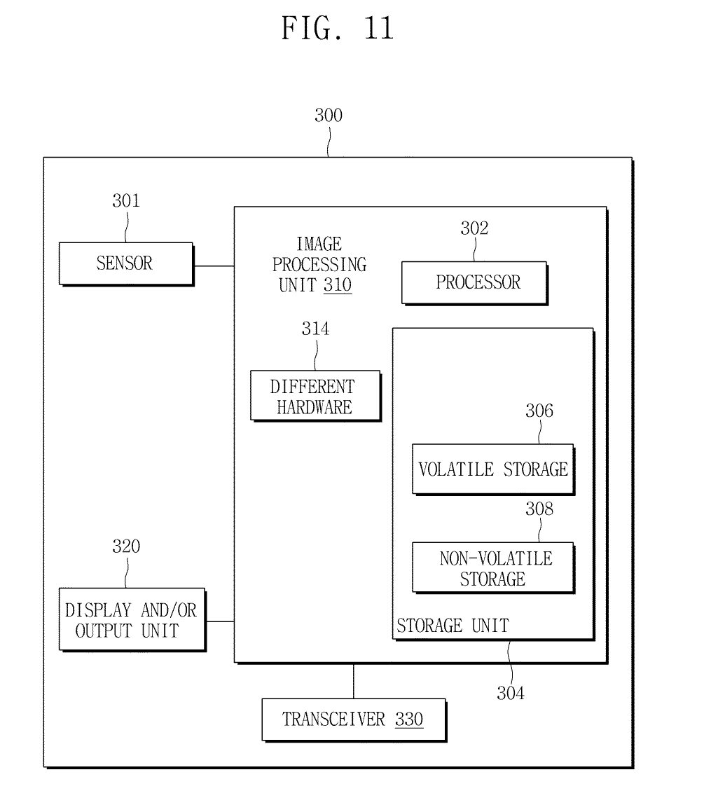

FIG. 10 is a block diagram of a mobile device including the image scaler shown in FIG. 4 according to at least another example embodiment of the inventive concepts.

Referring to FIG. 10, the mobile device 220 may be implemented as an image processing device, e.g., a digital camera or mobile phone having the digital camera, or a tablet PC.

The mobile device 220 includes a memory device 221 and an application processor 222 including a memory controller which controls an operation of data processing of the memory device 221, an input device 223, a display device 224, and an image sensor 225.

As the input device 223 is a device for controlling an operation of the application processor 222 or inputting data to be processed by the application processor 222, the input device 223 may be implemented as a pointing device such as a touch pad or computer mouse, a keypad, or a keyboard.

The application processor 222 may display data stored in the memory device 221 through the display device 224. The application processor 222 may control overall operations of the mobile device 220.

The image sensor 225 receives an image through a lens. Accordingly, the application processor 222 receives an image from the image sensor 225 and processes the received image signal in image. Further, the application processor 222 includes an image scaler 100 (i.e., the image scaler 100 shown in FIG. 4). The image scaler 100 may perform suitable scaling in consideration of a scaling ratio of an output image to an input image, and provide an image having a high quality in consideration of a frequency characteristic of each pixel.

FIG. 11 is a block diagram of a digital system 300 configured to process a digital image and/or a digital video.

The digital system 300 may capture, generate, process, modify, scale, encode, decode, transmit, store, and display an image and/or a video sequence.

For example, the digital system 300 may be represented or implemented as a device such as a digital television, a digital direct broadcasting system, a wireless communication device, a personal digital assistant (PDA), a laptop computer, a desktop computer, a digital camera, a digital recording device, a digital television capable of networking, a cellular phone, a satellite phone, a ground-based wireless phone, a direct bidirectional communication device (frequently referred to as a walkie-talkie), or another device capable of image processing.

The digital system 300 may include a sensor 301, an image processing unit 310, a transceiver 330, and a display and/or an output unit 320. The sensor 301 may be a camera or video camera sensor which is suitable for capturing an image or video sequence. The sensor 301 may include a color filter array (CFA) disposed on a surface of each sensor.

The image processing unit 310 may include a processor 302, different hardware 314, and a storage unit 304. The storage unit 304 may store images or video sequences before and after processing. The storage unit 304 may include a volatile storage 306 and a non-volatile storage 308. The storage unit 304 may include any type of a data storage unit such as a dynamic random access memory (DRAM), a flash memory, a NOR or NAND gate memory, or a device having a different data storage technique.

The image processing unit 310 may process an image and/or video sequence. The image processing unit 310 may include a chipset with respect to a mobile wireless phone which may include hardware, software, firmware, one or more microprocessors, a digital signal processor (DSP), an application specific integrated circuit (ASIC), a field programmable gate array (FPGA), or various combinations thereof.

The image processing unit 310 may include a local memory connected to an image/video coding unit and a front-end image/video processing unit. The coding unit may include an encoder/decoder (CODEC) for encoding (or compressing) and decoding (or decompressing) digital video data. The local memory may include a memory smaller and faster than the storage unit 304. For example, the local memory may include a synchronous DRAM (SDRAM). The local memory may include an “on-chip” memory integrated with other components of the image processing unit 310 and provide a high speed data access in a processor-integrated coding processor. The image processing unit 310 may perform one or more image processing techniques with respect to a frame of a video sequence to improve an image quality, and thus quality of the video sequence may be improved. For example, the image processing unit 310 may perform techniques such as demosaicing, lens rolloff correction, scaling, color correction, color conversion, and spatial filtering. Further, the image processing unit 310 may perform a different technique.

The image processing unit 310 may include the image scaler 100 of FIG. 4 according to at least one example embodiment of the inventive concepts. The image scaler 100 may perform suitable scaling in consideration of a scaling ratio of an output image to an input image, and provide an image having a high quality in consideration of a frequency characteristic of each pixel.

The transceiver 330 may receive and/or transmit a coded image or video sequence from and/or to another device. The transceiver 330 may use a wireless communication standard such as code division multiple access (CDMA). The example of the CDMA standard may include CDMA, 1×EV-DO, WCDMA, etc.

The image scaler according to at least one example embodiment of the inventive concepts determines the number of taps based on a scaling ratio. Since frequency characteristics of pixels are analyzed based on the number of taps, quality of an image can be improved and an amount of scaling computation can be reduced.

At least some example embodiments of the inventive concepts may be applied to an image scaler, and more particularly, to an image processing system.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. An image scaler, comprising:
a tap decision unit configured to determine a number of taps based on a scaling ratio, and
a pixel analyzer configured to analyze a frequency characteristic of a corresponding pixel based on the number of taps, the corresponding pixel being one of a plurality of pixels included in a input image.

2. The image scaler of claim 1, wherein the tap decision unit is configured to determine the scaling ratio by generating a comparison value based on an image resolution of the input image and an image resolution of the output image.

3. The image scaler of claim 2, wherein the tap decision unit is configured to set the number of taps to n when the scaling ratio is in a range of 1/n to n.

4. The image scaler of claim 1, wherein the pixel analyzer is configured to determine the number of pixels adjacent to the corresponding pixel in response to the number of taps.

5. The image scaler of claim 4, wherein the pixel analyzer is configured to determine color differences between adjacent pixels in a range of the number of taps and analyze frequency characteristics of the corresponding pixel.

6. An image scaler, comprising:
a processor; and
storage storing instructions that, if executed by the processor, cause the processor to,
receive an input image;
set a number of taps based on resolution of an input image;
determine a frequency characteristic of a corresponding pixel, from among pixels included in the input image, based on the number of taps;
select a filter coefficient based on the frequency characteristic; and
interpolate the input image using the filter coefficient.

7. The image scaler of claim 6, wherein the instructions, if executed by the processor, cause the processor to define a scaling ratio using a ratio of a resolution of an output image to a resolution of the input image.

8. The image scaler of claim 7, wherein the instructions, if executed by the processor, cause the processor to set the number of taps to n when the scaling ratio is in a range of 1/n to n.

9. The image scaler of claim 6, wherein the instructions, if executed by the processor, cause the processor to determine the number of adjacent pixels in based on the number of taps when frequency characteristics of pixels of the input image are analyzed.

10. The image scaler of claim 9, wherein the instructions, if executed by the processor, cause the processor to determine the frequency characteristic of the corresponding pixel by determining color differences between pixels adjacent to the corresponding pixel and determining the frequency characteristic based on the color differences.

11. The image scaler of claim 10, wherein the instructions, if executed by the processor, cause the processor to determine an average value from among absolute values of the color differences, and determine the frequency characteristic by determining whether the average value is greater or smaller than one or more threshold values.

12. The image scaler of claim 11, wherein the instructions, if executed by the processor, cause the processor to select an analysis direction of pixels adjacent to the corresponding pixel in any one of a vertical direction and a horizontal direction.

13. The image scaler of claim 6, further comprising:
a look-up table which stores a plurality of filter coefficients.

14. The image scaler of claim 13, wherein the instructions, if executed by the processor, cause the processor to choose the selected filter coefficient by choosing a filter coefficient, from among the plurality of filter coefficients stored in the look-up table, that corresponds to the determined frequency characteristic.

15. The image scaler of claim 6, wherein the instructions, if executed by the processor, cause the processor to perform image interpolation on the corresponding pixel using a value determined based on the filter coefficient and a pixel data value of the corresponding pixel.

16. The image scaler of claim 15, wherein the instructions, if executed by the processor, cause the processor to perform image interpolation on the corresponding pixel using a value determined by multiplying the filter coefficient by the pixel data value of the corresponding pixel.

17. An image scaler for scaling an input image into an output image, comprising:
a processor; and
storage storing instructions that, if executed by the processor, cause the processor to,
receive the input image, the input image including a plurality of pixels, the plurality of pixels including a first pixel;
determine a frequency characteristic of the first pixel based on a set of pixels from among the plurality of pixels;
interpolate the first pixel based on the frequency characteristic; and
generate the output image based on the interpolated first pixel,
the determining including selectively setting a total number of pixels included in the set of pixels based on a scaling ratio.

18. The image scaler of claim 17, wherein the instructions, if executed by the processor, cause the processor to receive the scaling ratio, the scaling ratio indicating a ratio of a resolution of the output image to a resolution of the input image.
